(19) United States
(12) Patent Application Publication
(10) Pub. No.: US 2005/0287044 A1
(43) Pub. Date: Dec. 29, 2005

(54) TEST APPARATUS AND METHOD

(75) Inventor: Govindarajan Natarajan, Poughkeepsie, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/710,183

(22) Filed: Jun. 24, 2004

(51) Int. Cl. B01L 3/00

(52) U.S. Cl. 422/102

(57) ABSTRACT

An apparatus and method is described for testing interactions between multiple reagents or components by means of a flow distribution body configured to have a three-dimensional network of conduits including feed holes for dispensing fluid, connected to a capillary channel bounded on at least one surface by a receiving surface, which in turn is connected to capillary flow promotion chimneys. The receiving surface may be a surface of a detachable receiving plate. Each feed hole is configured to terminate at a capillary flow control means at the intersection of the capillary channel to the feed hole. A uniform layer of reagent is formed or deposited on the receiving surface along the capillary channel. The feed hole, capillary channel and capillary flow promotion chimneys are configured so that when fluid is dispensed into the feed hole, capillary forces promote continuous flow of fluid along the capillary channel from the feed hole to the flow promotion chimneys until the trailing meniscus of the fluid in the feed hole stops at the capillary flow control means.

### BACKGROUND OF INVENTION

The present invention relates generally to testing biological and/or chemical interactions, and more particularly, to a device and a method for simultaneously testing interactions of multiple chemical or biological agents, such as drug interactions, immunosensing, protein characterization, DNA analysis, capillary electrophoresis and cell patterning in the chemical and pharmaceutical industries.

In order to improve the efficiency of drug discovery, leading pharmaceutical companies have implemented high-throughput screening (HTS) techniques for the evaluation of potential drug candidates. In high throughput screening, a reagent set A (for example, a biological target with appropriate assay reagents) is tested for reactivity with chemicals B1, . . . , BN (for example, compounds taken from a molecular library), where N can be a large number, on the order of millions. High throughput screening can enable the testing of large numbers of compounds rapidly and in parallel. Current efforts are standardized around the use of plastic consumables known as microtiter plates, or microplates. For example, a standard microplate 10 is illustrated in FIG. 1, having an array of wells 11. FIG. 2 illustrates a microplate 10 in a cross-sectional view, where wells 11 formed in the material of the microplate 10 are open at the top 12 and closed at the bottom 13. Thus, the wells 11 function as mini test tubes. A set of substances B1, . . . , BN can be arrayed in the wells 11 of the microplate 10 through the feed openings 12, and then reagent set A, which could include chemicals that test for the interaction with a specific biological target, can be mixed with each of the Bn, where n=1, . . . , N compounds. Detector instrumentation, for example, optical microplate readers, can then be used to detect interactions.

The pharmaceutical industry currently has a need for improvements in high-throughput screening technology to improve drug discovery efficiency and to keep costs down. Reagents and compounds used in drug discovery are often scarce and expensive, which has prompted the development of miniaturized assays with smaller assay volumes. Microtiter plates 10 are commercially available in a variety of standard well 11 formats (e.g. 96, 384, and 1536 wells per plate), with well dimensions typically on the order of a few to several millimeters. Assays performed in these plates typically use in excess of ten microliters of reagent per test point, which may be expensive. These types of reactions could theoretically be performed with submicroliter volumes of reagents, but to date such low volume assays have not achieved widespread adoption. One significant factor inhibiting the adoption of low volume assays is the lack of methods for reliable high performance fluid delivery.

Recently, Biebuyck et al. (U.S. Pat. No. 6,326,085 and U.S. Pat. No. 6,089,853, hereinafter Biebuyck) has described a specific patterning design to transfer fluid from a service cavity to a patterning cavity, which may have biotechnical applications. It is desirable in such testing to use smaller quantities of reagents, i.e. microliters or smaller, because of cost or limited availability of the reagent. However, using conventional microfluid devices, relatively large amounts of reagents are required, and it is difficult to deliver the precise amount of reagent required to the desired sites on the testing substrate. A method is needed whereby the microstructure can actually permit precise delivery of very small quantities of reagents to a testing substrate fluid instead of merely acting as a receiver. It is also desirable to precisely control the reactions of micro quantities of reagents, for example, by controlling the volume and flow rate of the reagent fluids. A means of maintaining such control of micro reactions for high-throughput testing has not been previously provided. A method of manufacturing such a testing and control means efficiently is also required.

Accordingly, there is still a need for a high throughput, inexpensive method for testing reagents and compounds.

It is yet another object of the present invention to provide a high throughput, inexpensive method of testing small, nanoliter quantities of reagents.

It is yet another object of the present invention to provide a means of testing multiple interactions between multiple reagents using a single scanning device.

It is yet a further object of the present invention to provide a method of manufacturing an apparatus for use in high throughput testing of multiple interactions between multiple reagents of nanoliter quantities.

Still other objects and advantages of the invention will in part be obvious and will in part be apparent from the specification.

### SUMMARY OF INVENTION

The above and other objects and advantages, which will be apparent to one of skill in the art, are achieved in the present invention, which is directed to, in a first aspect, a multilayer fluid delivery system, preferably comprising a ceramic material, that can handle several nanolitre in volume and the method of making the same. The multilayer fluid delivery system of the invention comprises micro feed holes and micro evaporation/flow promotion ports which are interconnected with micro channels.

A further aspect of the invention relates to an apparatus for testing reagents comprising a flow distribution body, which may optionally be afixed to a sealing plate, so as to form a plurality of conduits that are flow-isolated from each other, wherein each flow-isolated conduit comprises: a feed hole having a first opening at a first surface of the flow distribution body wherein the feed hole terminates at a capillary flow control means; a capillary channel having an interior surface bounded by a receiving surface of a sealing plate, the capillary channel being flow-connected to the feed hole through the capillary flow control means; and at least one capillary flow promotion chimney extending through the flow distribution body and flow-connected to the capillary channel so that fluid flowing along the capillary channel from the feed hole will enter the at least one capillary flow promotion chimney and promote continuous flow along the capillary channel. The flow distribution body comprises a dense material that is inert to fluids and the components and/or reagents to be tested. According to a preferred embodiment of the present invention, the flow distribution body comprises sintered, patterned greensheets. Preferably, the capillary channel has a volume about one order of magnitude less than the volume of the corresponding feed hole.

In another aspect of the invention, the micro feed holes, flow promotion chimneys and capillary channels have a surface roughness, to improve capillary fluid flow.

The apparatus of the present invention includes a capillary flow control valve which has an opening designed so that a trailing meniscus of fluid flowing from the feed hole into the capillary channel stops at the control valve opening.

In another aspect, the apparatus of the present invention includes a feed hole that is tapered from the opening into which fluids are dispensed at a first surface of the flow distribution body to a capillary flow control valve located at the terminal end of the feed hole, so that fluid introduced into the feed hole from the first opening flows continuously along the feed hole from the upper surface to the capillary flow control valve.

According to another aspect of the invention, there are a plurality of capillary flow promotion chimneys having a collective volume substantially equal to the volume of the feed hole, which ensures that there is no spillage or overflow of fluids between feed holes or flow promotion chimneys of separate conduits.

In yet another aspect of the present invention, the apparatus includes a sealing plate having a receiving surface that comprises a material, such as polydimethylsulfoxide or polydimethylsiloxane, having sufficient adhesive properties so that each of the capillary channels are flow-isolated from each other and permit the sealing plate to be released from the flow distribution body.

According to another aspect of the invention, a method of manufacturing an apparatus for high-throughput testing of multiple reagents is provided, the method comprising the steps of: providing a three-dimensional network design of flow channels to be formed in a flow distribution body; decomposing the three-dimensional network design into a plurality of discrete patterned layers; patterning a plurality of green sheets corresponding to the plurality of discrete patterned layers; and assembling the plurality of patterned green sheets to form the flow distribution body so that the flow distribution body has no substantial porosity or permeability between the flow-isolated channels and without substantial distortion of the flow-isolated channels. In a preferred embodiment of the invention, each flow-isolated channel includes a feed hole having a capillary flow control valve, and at least one capillary flow promotion chimney. The assembly of the patterned green sheets is preferably performed by laminating at a pressure and temperature so that there is substantially no deformation of the three-dimensional network of flow channels. Preferably, the method of patterning the greensheets includes overlap punching, and more preferably, using a single punch size.

In yet another aspect of the present invention, the method of manufacture of the test kit includes forming a patterned adhesive layer on the bottom surface of the flow distribution body where the adhesive layer has patterned openings corresponding to the capillary control values of the feed holes and the capillary flow promotion chimneys so that the flow promotion body may be afixed to a receiving plate by means of the adhesive layer to form said capillary channels. For example, the adhesive layer may be a polymer such as a layer of polydimethylsulfoxide.

In yet a further aspect, the present invention is directed to a method of testing multiple reagents comprising the steps of: providing a test apparatus comprising a plurality of flow-isolated conduits wherein each flow-isolated conduit includes a feed hole formed in a flow distribution body, the feed hole having a capillary flow control valve at a bottom surface of the flow distribution body, and at least one capillary flow promotion chimney formed in the flow distribution body, wherein the flow distribution body is afixed to a receiving plate to form a capillary channel bounded by a receiving surface of the receiving plate and connected to the feed hole through the capillary control valve, and the at least one capillary flow promotion chimney connected to the capillary channel so that fluid flowing along the capillary channel from the feed hole will enter the at least one flow promotion chimney and promote continuous flow along the capillary channel; dispensing a first fluid comprising a first reagent into one of the feed holes, so that a layer of the first reagent is formed on the receiving surface along the corresponding capillary channel; and dispensing a second fluid comprising a second reagent into one of the feed holes, so that a layer of the second reagent is formed on the receiving surface along the corresponding capillary channel so that the layer of the second reagent interacts with at least a portion of the layer of the first reagent. The capillary flow promotion chimneys are preferably configured to have a collective volume substantially equal to the volume of the feed hole. The capillary channels may be configured so that the area of deposited reagents to be tested is within an area less than or equal to the area capable of being analyzed by a single scan of a scanner.

According to one aspect of the invention, the receiving plate may be released from the flow distribution body after a layer of reagent or component has been deposited on the receiving surface and fixed (e.g. dried), and then afixing the receiving plate to another flow distribution body (which may be the same or different from the one used in depositing the first reagent) so that the layer of the first reagent on the surface of receiving plate is oriented at a non-zero angle to the capillary channels of the second flow distribution body, allowing a second set of reagents to be deposited along channel lines that intersect the first reagent pattern of lines on the receiving surface, thus forming an interaction array for rapid analysis. Alternatively, the method could include dispensing a rinsing fluid into the same flow distribution body, after depositing a first reagent, and then dispensing a second fluid with a second reagent to be deposited along the same channel. In yet another aspect, a receiving plate may be provided with a previously deposited set of components or reagents on the surface, and then afixed to a flow distribution body configured in accordance with the invention, to allow further testing and analysis. Additional sets of reagents may be provided as desired for a particular application in accordance with the invention.

### BRIEF DESCRIPTION OF DRAWINGS

The present invention, which provides an apparatus and method for high throughput screening of reagents, will now be described in more detail by referring to the drawings that accompany the present application. It is noted that in the accompanying drawings like reference numerals are used for describing like and corresponding elements thereof. The drawings are not necessarily drawn to scale.

FIG. 1 illustrates a standard microtiter plate for testing compounds.

FIG. 2 illustrates a cross-section view of a standard microtiter plate.

FIG. 3A illustrates a cross-section view of a test apparatus according to the present invention.

FIG. 3B illustrates a detail plan view of the top opening of a feed hole of the present invention overlying a portion of a capillary channel at the bottom of the feed hole.

FIG. 3C illustrates a detail cross-section view of a feed hole including a flow control valve according to the invention.

FIG. 3D illustrates a plan view of a feed hole, a capillary channel, and a set of chimney tubes, in accordance with one embodiment of the invention.

FIG. 3E illustrates a plan view of an alternate embodiment of the invention including capillary channels configured in a non-linear layout.

FIG. 3F illustrates a cross-section view of an alternate embodiment of the present invention, wherein the network of flow conduits and channels permits the receiving plate to be disposed along the same upper surface of the flow distribution body from which fluids are dispensed.

FIG. 4 illustrates a plan view of an embodiment of the inventive test kit.

FIG. 5 illustrates a plan view of an embodiment of the inventive test kit.

FIG. 6 illustrates a cross-section view of the flow distribution body during manufacturing of the inventive test kit.

FIG. 7 illustrates a plan view of an upper layer of an embodiment of the inventive test kit.

FIG. 8 illustrates a plan view of a lower layer of an embodiment of the inventive test kit.

FIG. 9 illustrates a plan view of a feed hole during manufacture of the test kit, according to an embodiment of the invention.

FIGS. 10A-10E illustrate a cross-section view of an embodiment of the test kit during a manufacturing process.

FIG. 11A illustrates a plan view of a receiving surface after deposition of a set of reagents A1, . . . , An, according to the invention.

FIG. 11B illustrates a plan view of a receiving surface after deposition of a set of reagents B1, . . . , Bm, oriented to intersect a previously deposited set of reagents A1, . . . , An, according to the invention.

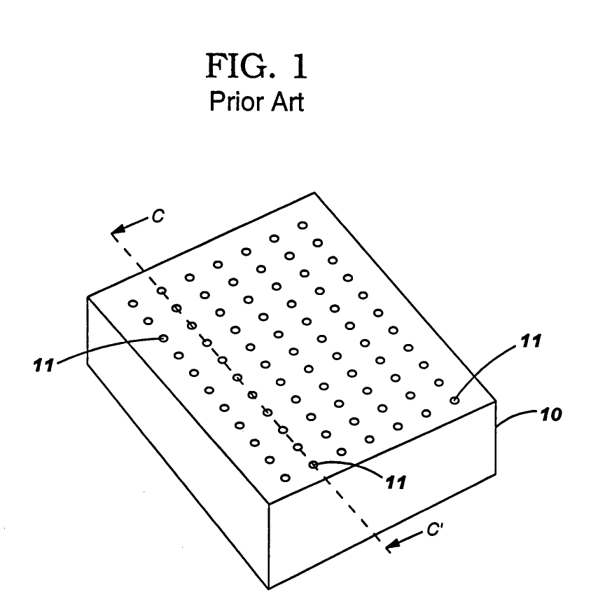

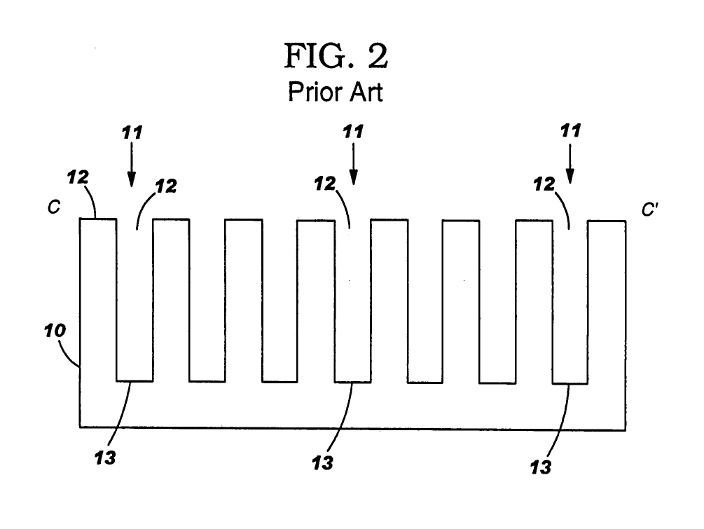

### DETAILED DESCRIPTION

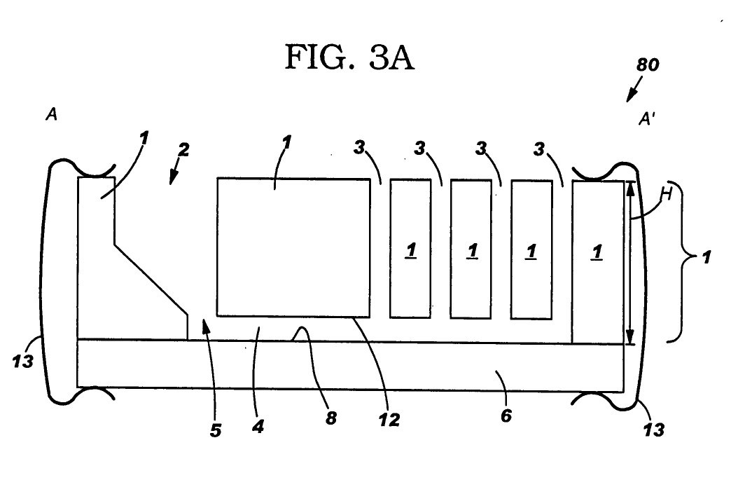

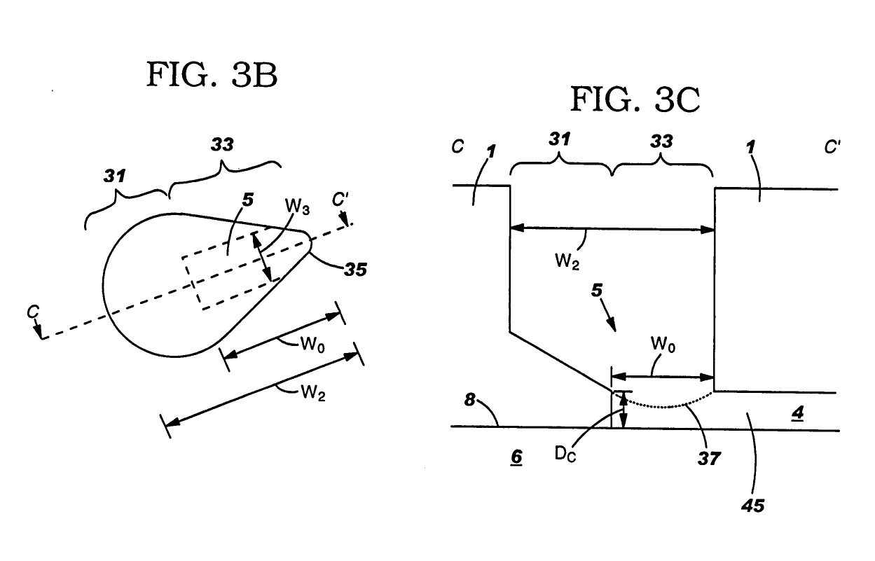

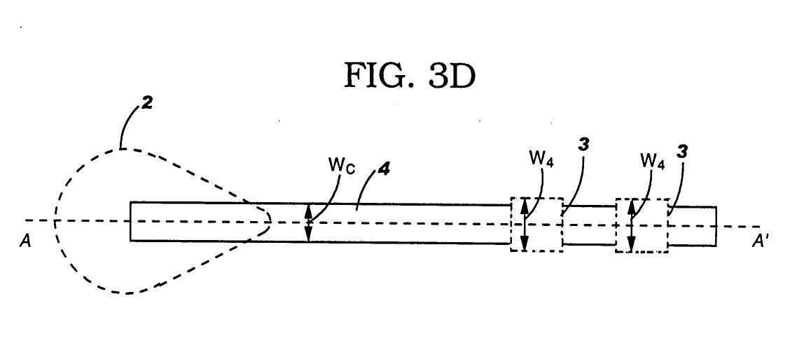

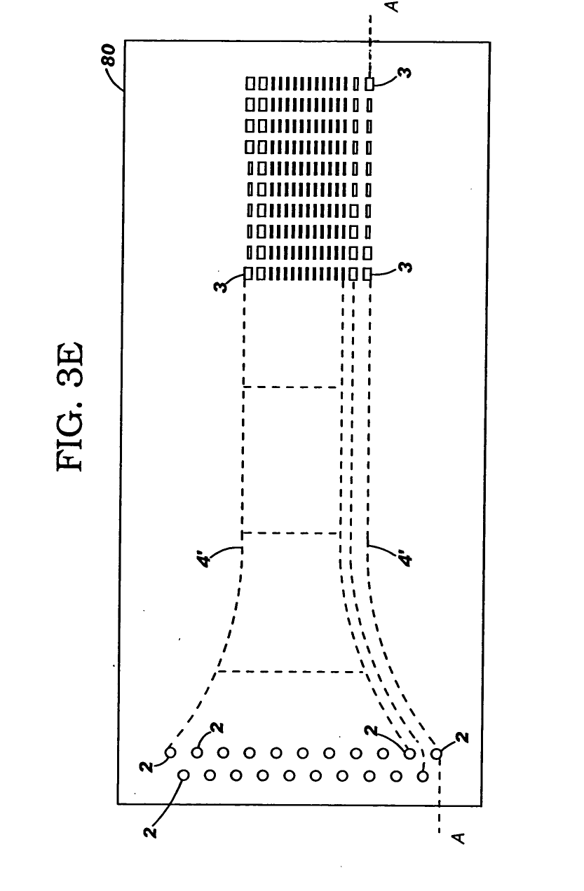

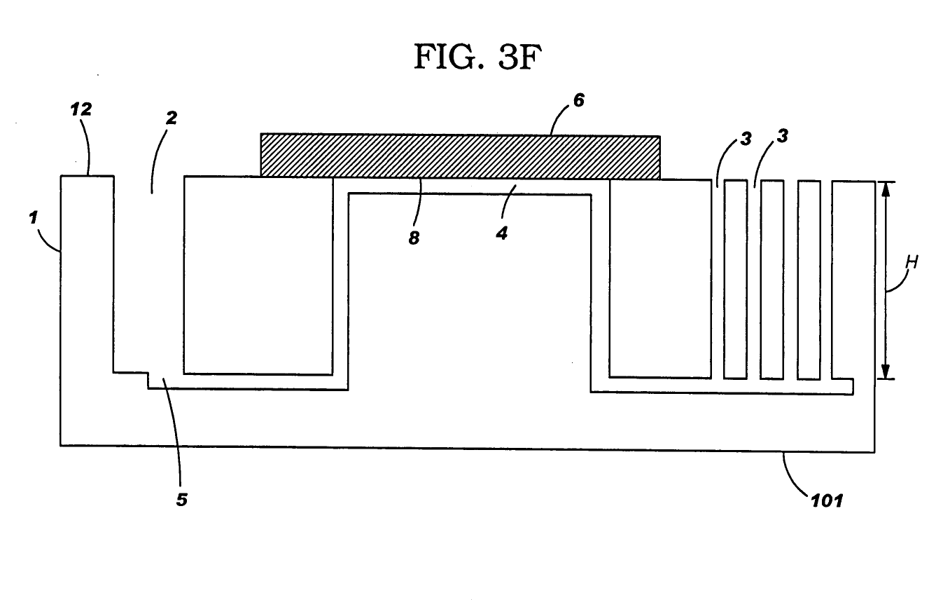

Referring to FIG. 3A, a preferred embodiment of the test kit 80 of the present invention is illustrated. The test kit is preferably a micromosaic assembly 80 comprising a three-dimensional network of flow channels, including reagent receiving channels 4, which are flow-isolated from each other, for depositing or binding reagents along the surface 8 of a reagent receiving plate 6 which is afixed to a distributor body 1. Alternatively, the test kit 80 may be provided wherein the receiving surface 8 is integrated within a flow distributor body 1. For example, if the distributor body 1 is transparent, analysis of reagents deposited on an interior receiving surface 8 may be performed without removal of the receiving surface 8 from the distributor body 1. The distributor body 1 preferably has grooves formed along a surface 12 of the distributor body 1, which will form flow-isolated receiving channels 4 when the distributor body 1 is afixed to the receiving plate 6. Alternatively, the receiving plate 6 may be designed to have grooves that will comprise the flow-isolated receiving channels 4 when afixed to the distributor body 1. The flow distributor body 1 is preferably made of glass or ceramic, but can be other suitable materials that are dense (i.e. having no substantial permeability), and are inert to the fluids and their constituent components to be used in the desired application. Preferably the body 1 is formed from a material that is machineable. Examples of suitable materials for the flow distributor body include, but are not limited to, alumina, alumina with glass frit, aluminum nitride, aluminum nitride with frit, plastic, polymer and glass. Most preferably, the distributor body 1 is formed from a sintered ceramic/glass, such as green sheets.

The receiving plate 6 is preferably afixed to the distributor body 1 so that receiving channels 4 are formed along grooves in the distributor body 1 and a seal is formed sufficient to prevent fluid leakage, so as to flow-isolate receiving channels 4 from each other. The receiving seal plate 6 may be permanently afixed to the distributor body 1, but preferably the surface 8 has adhesive properties that allows the plate 6 to be releasable from the distributor body 1, and then re-joined to the distributor body 1 so that flow-isolated receiving channels 4 may be formed again, preferably, in a different orientation along the surface 8 of the receiving plate 6. The receiving plate 6 may optionally be afixed to the distributor body 1 by a securing means, such as a clamp 13, sufficient to provide pressures to form flow-isolated receiving channels 4 without significant distortion of the three dimensional network of flow channels. The securing means is preferably designed to have a profile that can accommodate standard handling and processing procedures. The receiving plate 6 is formed so that its surface 8 can receive desired reagents, where a reagent in a fluid may be any chemical or biological component of interest for testing, including but not limited to chemical, biochemical, pharmaceutical or bioassay testing. The surface 8 may receive a component or reagent by a physical or chemical process, such as adsorption or absorption, preferably by adsorption. Examples of suitable materials for the receiving plate 6 include, but are not limited to, an adhesive coated material on a substrate, where the coating acts as a receiving surface and has adhesive properties such that the bond strength is suitable for sealing the receiving plate 6 to the flow distribution body 1. If desired, the adhesive may have a peel strength so that the coated receiving plate 6 can be easily removed for subsequent testing and analysis. The substrate material of the receiving plate 6 may be a plastic, a glass, a metal, a ceramic, a composite or a polymer, or the seal plate 6 may be formed using a substrate material having the required adhesive and receiving properties without an additional coating, for example, a polymer such as polydimethylsulfoxide (PDMS) or polydimethylsiloxane. For example, PDMS is known to be suitable as a receiving surface 8 for use in bioassay applications, and has sufficient tackiness properties such that flow isolated channels 4 may be formed in a first orientation along receiving plate 6, and then peeled and re-sealed to from flow isolated channels 4 is a second orientation along the receiving plate 6.

In accordance with the present invention, each of the receiving channels 4 has flow connections to a feed hole 2 for dispensing fluid into the channel 4, and one or more flow exit chimneys 3, so that when fluid containing a reagent is dispensed into feed hole 2, it flows along channel 4 towards exit chimneys 3 at a rate sufficient so that the reagent is deposited (or binds) relatively uniformly along the receiving surface 8 of channel 4. A means for causing continuous, controlled flow along the channel 4 may be provided, such as a pumping device (not shown). More preferably, the channel 4 is a capillary channel, and the exit chimneys 3 are also capillary structures that provide flow promotion as described in more detail below. For the purposes of this description, a capillary structure is a structure in which fluid flow is driven substantially by capillary forces due to wetting of the surfaces by the fluid. The feed hole 2 is preferably tapered, so that flow is accelerated down the feed hole 2 by capillary forces towards a capillary control valve 5, as described in more detail below. The three-dimensional network of conduits may have any suitable configuration; for example, the opening of the feed hole 2 may be formed on any convenient surface of body 1 that may be suitable for dispensing a reagent or component into the flow distribution body 1.

In the preferred embodiment, when a fluid is dispensed into the feed hole 2, the fluid flow is effected by capillary action and the rate and volume of flow through the capillary channel 4 is controlled by the combination of capillary flow control valves 5 and capillary flow pumps 3 as described further below. The fluid may be such that a component or reagent in it can be deposited (physically or chemically) onto the surface 8 of the seal plate 6, for immediate testing and/or further processing or analysis.

The feed/supply hole 2 in the preferred embodiment is illustrated in plan view in FIG. 3B. The shape of the feed hole 2 can be any shape in plan view, but preferably is a tapered shape, where a wider portion 31 is sufficiently wide to accept a small metered amount of fluid from a fluid dispensing means, such as a standard micropipette (not shown), and a narrower portion 33 which tapers to a tip 35 and overlaps the channel 4, where a flow control means 5 is formed at the intersection of the channel 4 and the bottom of the feed hole 2. The flow control means 5 may be a flow control device, such as a valve. In a preferred embodiment, the flow control means 5 is designed as a constricted opening, wherein a fluid meniscus will be trapped so that the fluid column in the feed hole 2 will flow into the channel 4 until the trailing meniscus stops at the flow control means 5. Hereinafter, the flow control means 5 will be interchangeably referred to as a valve 5, without intending to limit the configuration of the flow control means.

Without intending to limit the present invention, it is believed that the surface tension of the fluid maximizes the capillary force in the direction of the narrow end 35 of the feed hole 2. This results in consistency in flow of the fluid down the feed hole 2 towards the valve mechanism 5, so that pockets of air within the fluid column are reduced, or preferably eliminated. The feed hole 2 is also preferably narrower towards the flow control mechanism or valve 5 at the termination of the feed hole 2, as illustrated in the cross-section view at line C-C′ of FIG. 3C. The taper towards the bottom of the feed hole 2 allows gravitational and capillary forces to drive and/or pull the fluid in a continuous flow into the channel 4 and keep the trailing meniscus 37 of the fluid 45 moving down the feed hole 2 towards the valve 5, where the meniscus 37 stops at the flow control means 5 when the capillary pressure of the trailing meniscus equals the capillary pressure of the leading meniscus. The taper towards the bottom of the feed hole preferably varies smoothly, but may occur in small steps, as long as a sudden change in the cross-section of the feed hole 2 is avoided, which could result in a stoppage of flow in the capillary flow path, which comprises the feed hole 2, the channel 4 and the capillary pumps 3. When the channel 4 is filled with the reagent fluid, the trapping of the trailing meniscus 37 at the valve 5 acts to maintain complete wetting of the channel 4 until the desired reaction and/or deposition of reagent or component is completed within the channel 4, and also allows additional fluid to be dispensed into the feed hole 2 and to fill channel 4 without permitting air pockets to be introduced into the channel 4 until desired.

The length W2 of the feed hole 2 along the cross-section C-C′ from the narrow to wide end 35 of the feed hole 2 is preferably in the range 100 μm to about 3 mm. The volume of the feed/supply hole 2 is preferably less than 10 μliter, more preferably less than 2 μliter, depending on the application. The flow control means 5 is formed at the intersection of the bottom of the feed hole 2 and the channel 4, and having a lengthwise overlap W0 with the length W2 of the feed hole 2. The length W0 of the valve is preferably less than about 90% of W2, and more preferably about 50% of W2. The width W3 of the 5 is preferably equal to or smaller than the width of the channel 4. The feed hole 2 and the valve 5 are designed so that a dispensed fluid 45 drains through the feed hole 2 continuously into the capillary channel 4, but stops flowing when the feed hole 2 empties and the trailing meniscus 37 of the fluid 45 stops at the flow control means 5 configured as a constricted or capillary opening. The trailing meniscus 37 may be concave or convex in shape, depending on the fluid.

The channel 4 is bounded on by appropriate grooves or cutout shapes in the distributor body 1, and bounded on one side by the receiving surface 8 of the sealing plate 6. FIG. 3A illustrates a cross-sectional view along the line A-A′ (see plan view FIG. 3D) cutting through the length of the channel 4. The channel 4 is not required to lie along a straight line, as illustrated in the plan view of an embodiment of the test kit assembly 80 where the feed holes 2 are large enough to accommodate standard micropipettes, but the channels 4 and capillary flow pumps 3 are sufficiently small to allow capillary flow through a large number of channels 4 by using angled or non-linear channel paths 4′ as illustrated in FIG. 3E. This configuration allows a large number of channels 4 to be formed in an area that can be analyzed simultaneously by means of a single scan using commercially available scanners. The width W4 of the channel 4 is preferably less than about 150 μm and the height of the channel Dc is preferably less than about 100 μm. The cross-section of the channel 4 in this embodiment is rectangular, but any shape may be used. The volume of the capillary channel 4 is preferably about one order of magnitude less than the volume of the corresponding feedhole 2.

The capillary flow pump “chimney” structures 3 are provided to drive continuous flow through the capillary channel 4 at a rate such that the deposition of the reagent on receiving surface 8 is substantially uniform along the channel 4. Without intending to limit the invention, it is believed that the flow rate along the channel must be balanced with the diffusion rate of the reagent through the fluid to allow uniform deposition along the receiving surface 8. The flow promotion structures 3 are scaled so that the total volume of the pumps is approximately equal to, or slightly greater than the volume of the feed hole 2. For example, referring to FIG. 3D, the capillary flow pumps 3 preferably have a width W4 that is less than about two times the width Wc of the channel 4, and more preferably about 1.5 Wc. The shape of the cross-section of the chimney structure 3 is preferably rectangular, but other shapes will work. The capillary flow promotion chimneys 3, which are flow-connected to a given capillary channel 4, need not be configured to only run vertically through body 1, but may be configured as a three-dimensional network of conduits.

FIG. 3F illustrates an alternative embodiment wherein the channel 4 comprises an inset feature or trench along the upper surface of body 1, wherein the top surface 12 is the same surface of body 1 where the opening of the feedhole 2 is formed. A seal plate 6 is afixed to the distributor body 1 to form the receiving channels 4, but does not cover the openings of the feedhole 2 or the flow promotion channels 3. This embodiment has the advantage of easy accessibility of the receiving plate 6 for the end user. In addition, depending on the application and the nature of the material used to form the distributor body 1, additional means (not shown) may be provided through the opposite surface 101 of the body 1 to affect the flow and/or the reaction. For example, additional light (e.g. UV radiation), electrical or magnetic or thermal means may be provided through the surface 101 as appropriate for the application.

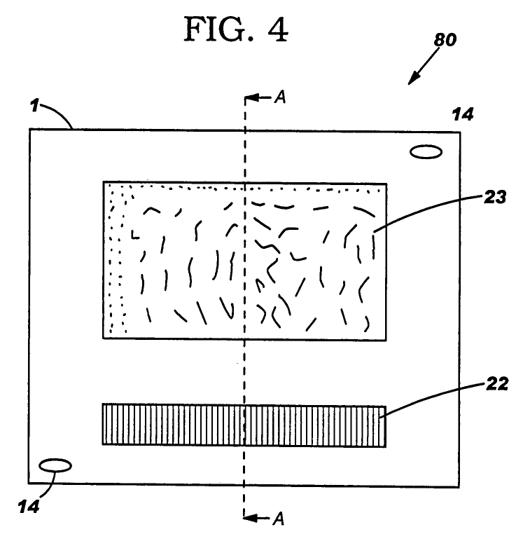

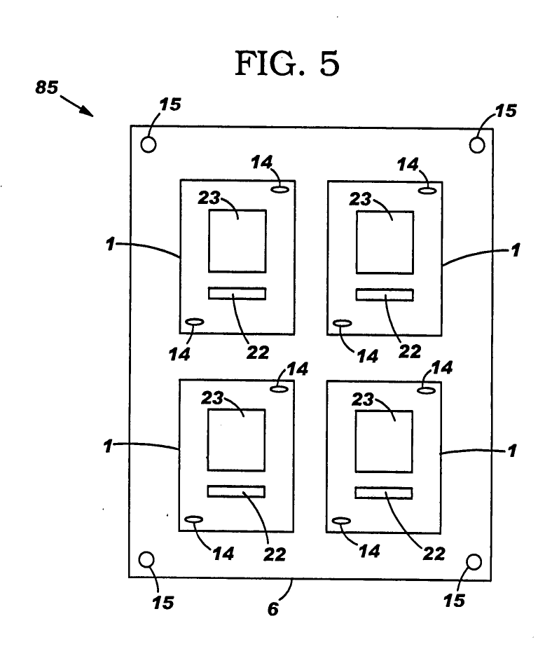

FIG. 4 illustrates a plan view of a test kit 80, including a flow distribution body 1. As described previously, there are a set of feed/storage holes 2 in region 22 and capillary flow pump chimneys 3 in region 23 in body 1. The alignment holes/slots 14 may be provided to align the flow distribution body 1 to the receiving plate 6, or may be provided for alignment during manufacturing of the body 1, as discussed further below. FIG. 5 illustrates a plan view of a test kit 85 including multiple flow distribution bodies 1 in place on a single large receiving plate 6. Additional alignment holes 15 may be provided as necessary, for example, to provide alignment of the test kit 85 and/or 80 with external devices, for example, a scanner/instrument and/or additional processing tools for further analysis. Thus, in accordance with the present invention, multiple flow distribution bodies 1 may be provided on a single receiving plate 6 to increase productivity for certain applications.

In summary, the present invention provides for a receiving surface for depositing reagents or components for testing and analysis along at least one channel. Preferably the test kit includes a flow distribution body that comprises a three-dimensional network of flow channels, where preferably, the flow is preferably driven by capillary forces.

Method of Manufacture

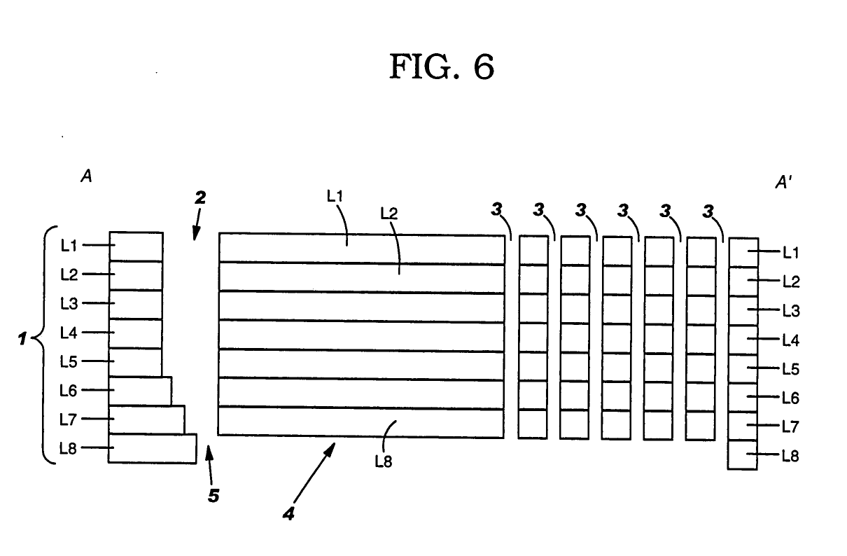

Referring to FIG. 6, a preferred method of manufacturing the flow distribution body 1 is described. As discussed above, the body 1 is designed to have a three-dimensional network of flow channels or conduits. In a preferred embodiment, the body 1 is designed to include feedholes 2, channels 4 and flow promotion channels 3, for example, as illustrated in FIGS. 3A-3F, although the method of manufacture is not limited to a particular three-dimensional network of conduits. Preferably, the channels 4 and flow promotion chimneys 3 are capillary channels. In addition, alignment holes 14 (the alignment holes 14 are unconnected to the network of flow channels 2, 4, 3) are designed to run vertically through the thickness of the distribution body 1, as illustrated in FIG. 4, showing a plan view of the distribution body 1. The three dimensional design of body 1, for example, as illustrated in FIG. 3A, is then decomposed into a number of layers as illustrated in FIG. 6, wherein each layer L1, . . . L8, has a defined pattern for that layer. The alignment holes 14 are designed to allow subsequent alignment of the layers after machining the pattern defining the three-dimensional network. The alignment holes 14 may be any suitable size and shape, as illustrated in FIG. 4. The number of layers may be any suitable number so that the individual layers of machineable material to be used in forming the body 1.

Preferably the layers are sheets, known as green sheets, containing particles such as alumina, ceramic, glass ceramic and the like, which are machineable, and then can be sintered to form a solid body. The green sheets are cast in a binder, such as a polymer. Green sheets typically range in thickness from about 1 to 30 mil (a mil is one thousandth of an inch). For example, in a preferred embodiment, about eight green sheets, L1, L2, L3, L4, L5, L6, L7 and L8, each having a thickness of 6 mil may be used to form a distribution body 1 having thickness about 1 mm. Greensheets may be formed from particles of materials such as alumina, glass, glass-ceramic, plastic, silicon, metal, inorganic and organic materials, composites thereof, or the like. The green sheet layers are patterned from the three dimensional design for the network of flow channels including feed holes 2, the channels 4 and flow promotion chimney structures 3, and valve structures 5. In the example illustrated in FIG. 6, the channel 4 has a height equal to the thickness of a green sheet, which may be in the range about 25 μm to 760 μm (or in the range from about 1 mil to about 30 mil) and is preferably less than 100 μm, and more preferably about 25 μm.

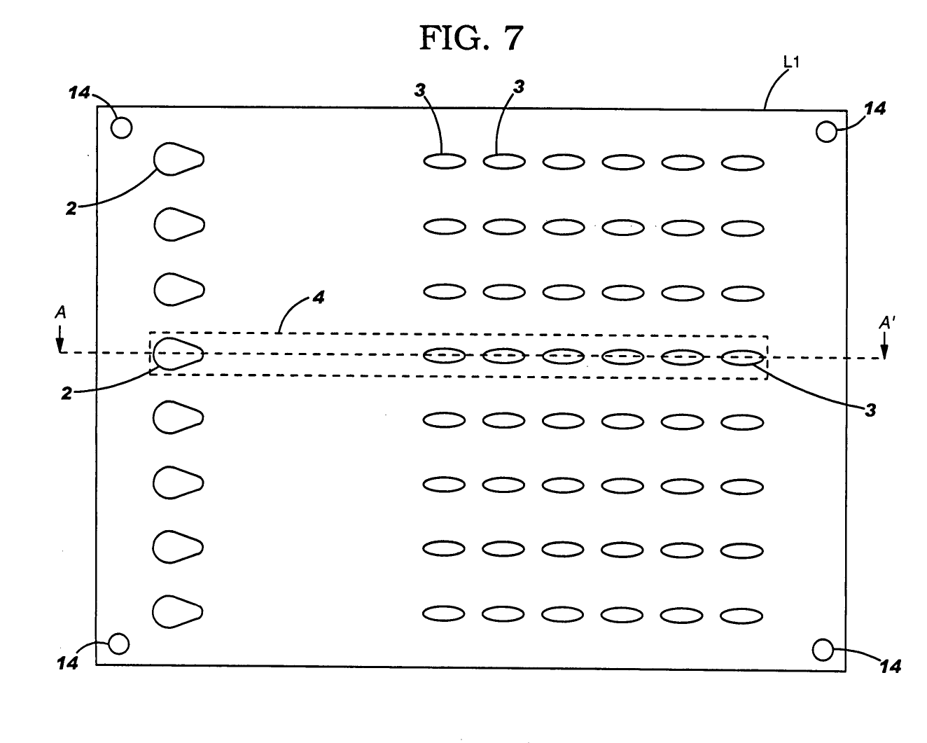

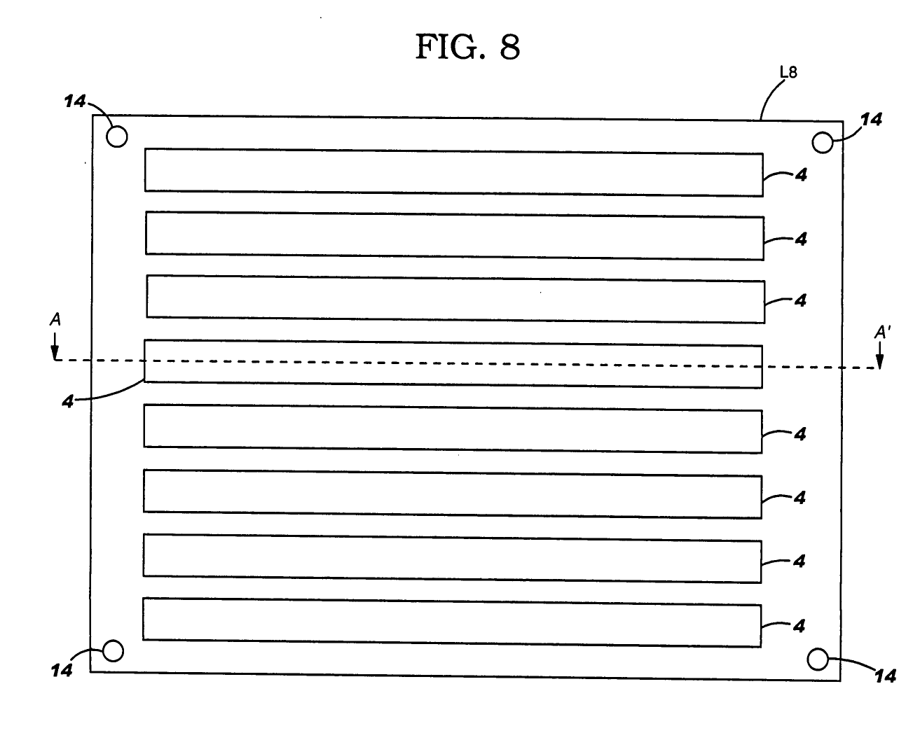

The tapered width of the feed hole 2 may be approximated by a step wise narrowing of the openings of several layers. For example, referring to FIG. 7, in an embodiment where, for clarity of explanation, the feed holes 2 and flow promotion holes 3 are aligned along linear channels 4, feed holes 2 and flow promotion holes 3 are formed having the same dimensions in layers L1 through L5. Then, starting from layer L5 about two thirds from the bottom of feed hole 2, the patterned openings for feed hole 2 are made successively more narrow from layer L6 to L7, until the desired width of the control valve 5 is achieved between next to last layer L7 and final layer L8 containing the grooves for channels 4 (see FIG. 8).

Each layer, e.g. L1 through L8, is patterned. In a preferred embodiment, the patterns are machined using standard punch and die sets for forming patterns such as vias used in semiconductor manufacturing, to pattern green sheets. In conventional ceramic multilayer formation it is a normal process to use a single punch size and die size to form thousands of holes, generally known as vias in greensheets. The punch size and die size depends on the need and usually is less than 150 μm punch size and less than 180 μm bushing size. In manufacturing die design, one uses a cluster of such punches, for example 64, 128, 256, etc. in a dieset to form vias, generally less than 200,000 per greensheet. The speed of hole formation is very important as a single foundry has to process a minimum of 20,000 to 50,000 greensheets a day. A single greensheet is normally punched within 15 secs to under 1 minute depending on the number of vias per stroke. Hence it would be uneconomical and impractical for a business to form multiple size and shaped holes using multiple size and shaped punches and bushings, as it involves tremendous process and down time due to numerous die changes that would be required per sheet. Thus, according to the present invention, the patterned features of the sheet are formed using a single small punch size and die size to form the entire pattern using overlap punching, which provides a foundry-capable process.

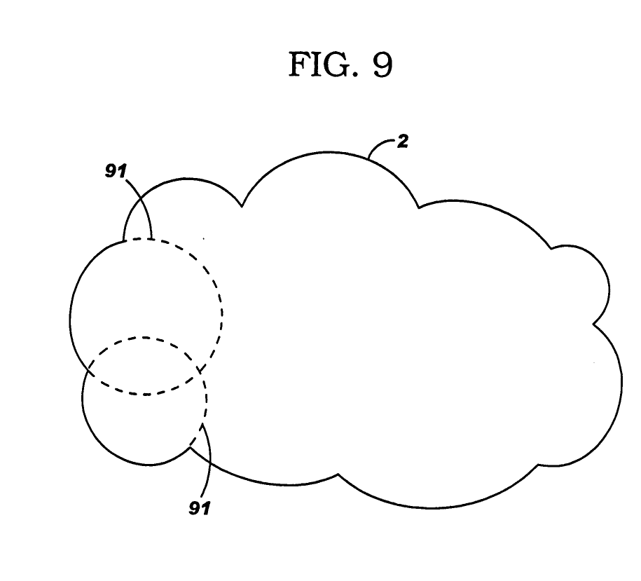

Typically, the standard punches may have diameters about 100 μm in diameter, and the corresponding die bushings have a diameter ranging from about 118 μm to about 130 μm, which provide sufficient clearance depending on the type of green sheet being patterned. The patterned features will typically be larger than the standard punch diameters, so the features, such as feed hole 2 and channel grooves 4 are formed using overlap punching. For example, referring to FIG. 9, a feed hole 2 may be formed from overlap punching using a standard punch size 91. The amount of successive overlap of punching is less than 90%, and preferably about 50%. The overlap punching sequence may be automated, and may be performed in any suitable order (i.e., the sequence of punches need not be done in a sequential order). Preferably, all of the patterns, including the alignment holes 14, are formed using overlap punching with the standard via punch size 91. The extent of overlap depends on the smoothness or roundness desired for the edge of the larger hole. Since the punched out ceramic piece (also known as a slug) is smaller than the single punch bushing size, the waste is removed simultaneously as the high speed punch process progresses. It is of great help to clean the punched out pieces simultaneously as this helps the manufacturing cost and time. Remaining debris from the punching are removed from the patterned layers by cleaning methods, as known in the art.

The patterned green sheets (L1, . . . , L8) are then stacked, using alignment holes 14 for alignment, which preferably have been formed, i.e. punched simultaneously with the patterning, which ensures alignment robustness. The stack of greensheets are then laminated, using techniques known in the art, at a pressure and temperature so that there is no deformation of the pattern of holes and channels, preferably at a pressure less than about 1000 psi and at a temperature less than about 90° C. By way of example, a typical greensheet using polymer binder such as poly(methyl methacrylate) (PMMA), or polyvinyl butyral (PVB), preferable lamination conditions are about 800 psi and about 75° C.

Multiple kits may be formed using standard greensheets, which typically have dimensions of 215 mm×215 mm. The final distributor body 1 of the present invention may typically have plan view dimensions of 25 mm×25 mm, so that thirty-six of the distributor bodies 1 may be formed from a single standard greensheet of dimension 215 mm×215 mm. The laminated greensheets may be cut or sliced to the desired dimensions for the test kit being formed.

The laminated structure (body 1) is then densified, so that there is no connected porosity in the matrix (which may be ceramic, glass, plastic, or other suitable materials), without deformation of the holes and channels within the body 1. This may be performed, for example, by sintering at temperatures less than 1500° C. The sintered body 1 may be require a flattening cycle, as known in the art.

After densification, the body 1 is cleaned, for example using ultrasonic bath and/or a solvent, to remove particles and any organic compounds.

The top and bottom surfaces of the densified laminate may be planarized, for example by grinding and polishing, using methods known in the art. The holes may be filled, for example, with parafin or wax during polishing to protect the holes from clogging, prior to a surface finishing operation. After polishing, the wax, if any, is removed, for example by a solvent such as acetone, and the body 1 is cleaned again, for example by ultrasonic bath and/or solvent.

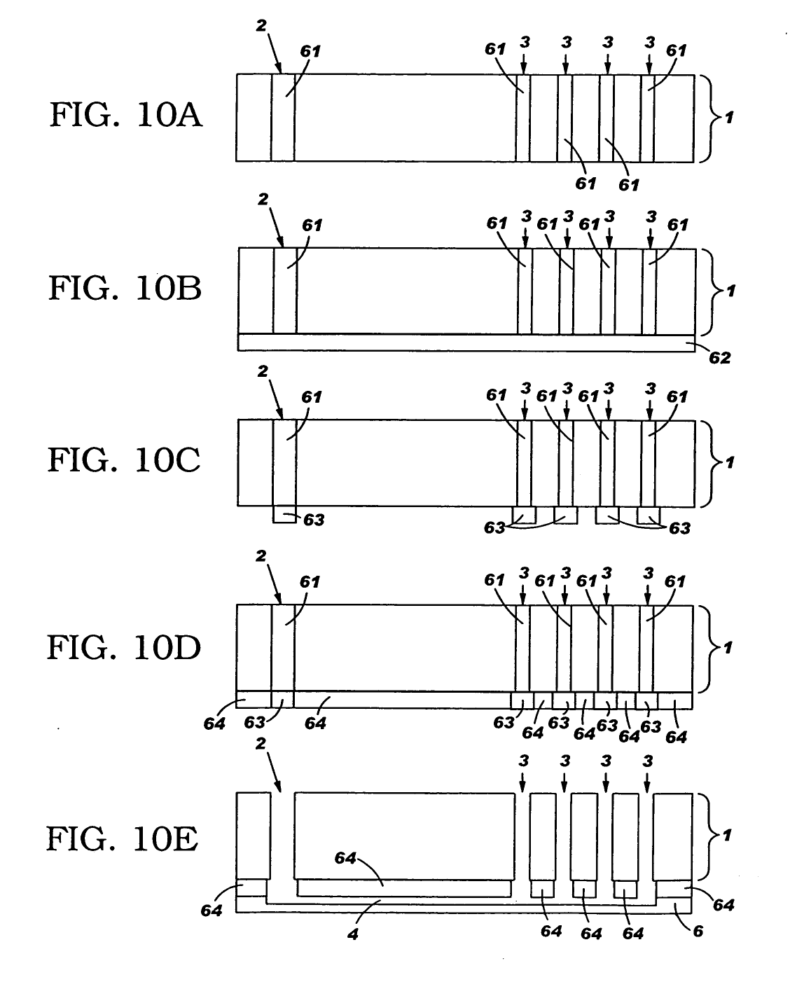

With reference to FIGS. 10A-10E, in one embodiment, an intermediate sealing or adhesive layer 64, for example comprising PDMS, may be afixed to the distributor body 1, which allows the distributor body to be easily afixed to a separate receiving plate 6. The seal layer 64 may be formed directly on a distributor body 1, which may be formed with or without grooves for channels 4, to be afixed to a receiving plate 6 that may have grooves which will comprise channels 4 when afixed to body 1. Referring to FIG. 10A, a sintered ceramic body 1 having feed holes 2 and chimney flow promotion holes 3 is formed as described above. The entire ceramic body is then subjected to a low melting wax fill 61 to fill the holes 2, 3. Next, as illustrated in FIG. 10B, a layer, for example, of photoresist 62 is spun on one side of the ceramic body. Layer 62 could be a dry resist, in which case layer 62 is attached or laminated to body 1. The photoresist is patterned, for example by lithographic techniques, to form caps 63 that protect the hole openings 2, 3. FIG. 10C illustrates selective developing/etching/deleting of the photoresist to leave caps 63 only in the area where the holes 2 and 3 are located. The caps 63 are wider than the holes, by an amount sufficient to protect the hole openings, e.g. by about 10% wider than the diameter of the hole openings. FIG. 10D illustrates formation of a polymer seal layer, such as PDMS layer 64 by a standard spin and doctor blade process. FIG. 6E illustrates the removal of photoresist 63 and wax 61 by acetone to form a PDMS seal layer 64 directly on to the ceramic 1, with open holes 2, 3. A rigid receiving plate 6 is then provided, which may have grooves formed by any known technique, which will form the channels 4 when afixed to the body 1 by means of the patterned seal layer 64. Alternatively, the patterned seal layer 64 may be formed on a separate substrate (not shown), such as glass, and then forming a patterned photoresist layer, and then spinning on a PDMS layer, removing the patterned photoresist and then transferring the patterned PDMS seal layer 64 to the patterned distributor body 1 using alignment holes 14.

It has been observed by Applicant that altering the surface roughness of the flow channels impacts the wettability of the capillary conduits. In accordance with the present invention, the network of conduits may be formed to have a desired surface roughness, depending on the size distribution and composition of particles selected to form the green sheets.

It will be appreciated by those skilled in the art that the formation of the three-dimensional network of flow channels according to the invention, is not limited to the embodiments discussed above, and may be formed using a variety and combination of three-dimensional network of conduit designs and materials.

Method of Using

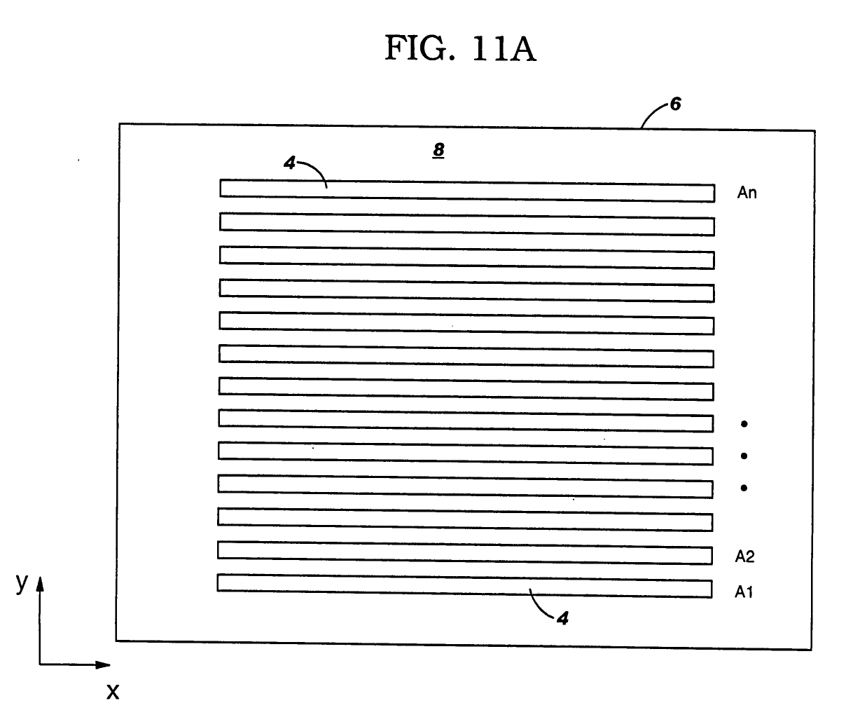

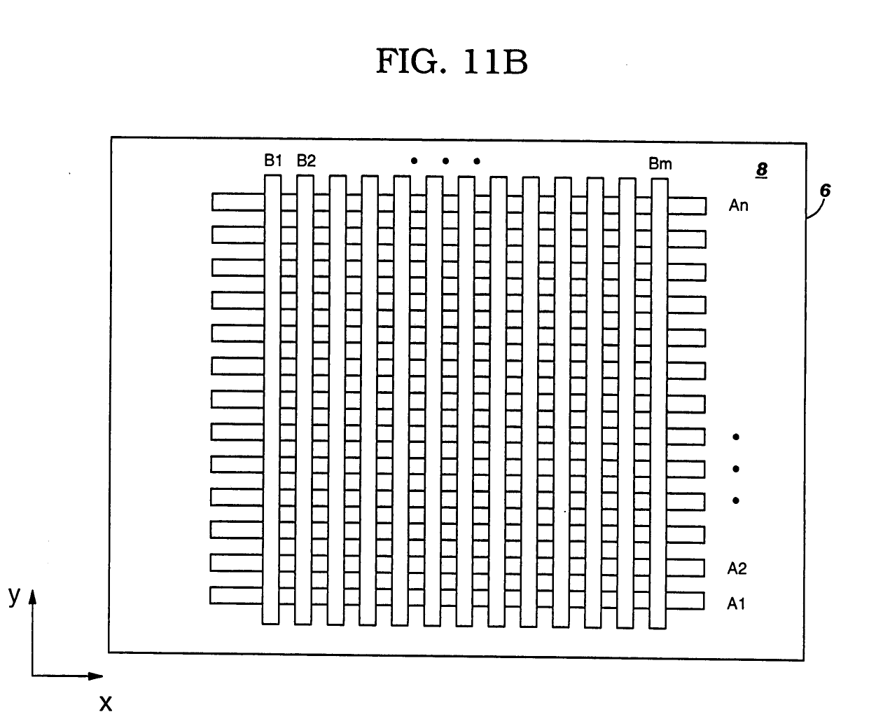

In accordance with the present invention, testing of multiple reagents or components may be performed by using the flow distribution body 1 to deposit components of interest on the receiving plate 6 along channels 4 in a sequential manner. Scanning devices, such as fluorescent scanners used in biological analysis, may have a small scanning area, for example, about 22 mm², it may be preferable to design the channels so that the multiple channels are grouped within an area that can be scanned in a single pass by the scanning tools, and design the feed holes 2 to be spaced apart and sufficiently large that standard micropipettes may be used to dispense the fluids containing the components of interest. Thus, the flow distribution body 1 may be designed so that the feed holes 2 are staggered and spaced apart, but flow connected to channels 4 that are tightly nested, as illustrated in FIG. 3E. However, in the foregoing discussion, for clarity of explanation, methods of performing testing in accordance with the present invention are illustrated using channels that are substantially linearly elongated rectangular shapes, although any suitable deposition shape may be used. Referring to FIG. 11A, in a preferred embodiment, a surface 8 of receiving plate 6 is illustrated in plan view, wherein the plate 6 is afixed to a flow distribution body 1 so that flow isolated channels 4 are formed. Preferably the flow distribution body 1 includes capillary flow channels 4 and capillary flow promotion chimneys 3. The testing is performed by dispensing one or more fluids of a known volume, containing component A of interest, into feed holes 2, for example, by using pipettes. As known in the art, micropipettes may be used for dispensing fluids manually or using a machine to dispense multiple fluids containing components of interest. The concentrations of the reagent A dispensed into different feed holes 2 may be the same or different, depending on the application. As discussed above, in the preferred embodiment, the feed holes 2 are tapered, so that the fluid is driven by capillary forces down the feed hole 2 into the capillary channel 4, and the capillary force of the leading meniscus will result in continuous flow along channel 4. As the leading meniscus reaches each one of the flow promotion tubes 3, it will flow up the chimneys 3 in sequence until the capillary pressure is balanced with the pressure of the trailing meniscus, and then continue to flow along the channel 4 to the next flow promotion tube 3, thus promoting flow along the channel at a substantially laminar flow rate such that the channel 4 is filled with fluid without air bubbles, and at a rate that allows sufficient diffusion of the component A within the fluid to allow deposition of component A at concentrations A1, . . . An on the receiving surface 8 along the channels 4 that is substantially uniform along the channel 4. The volume of fluid dispensed into the feed hole 2 is preferably contained within the feed hole 2 so as to avoid spillage and potential cross-contamination with the other feed holes 2.

Referring to FIG. 11A, a plan view of the receiving surface 8 of the receiving plate 6 is illustrated, having deposited thereon a film comprising component A along channels 4 oriented along the x-direction. In this example, there are multiple channels 4 that were flow isolated from each other along the y-direction. The concentration of component A may be different within different channels 4 along the y-direction, but is preferably essentially uniform along each individual channel 4 along the x-direction. In some applications, for example, it may be desirable to further influence the mobility of the component A or the flow of the fluid by techniques such as, but not limited to, applying an electrical potential, a magnetic field or a temperature gradient across the channel, or other similar techniques that may be known in the art.

Subsequently, in a preferred embodiment, the receiving plate 6 having the films of one or more components may detached from the flow distribution body 1. The deposited channels or films may be treated by methods known in the art to ensure binding of the films to the receiving surface 8, such as drying or thermal treatment. The plate 6 having the films comprising the first components may be then attached to a flow distribution body 1 in a different orientation, e.g. with the channels 4 oriented along the y-direction, so that a second set of flow isolated channels 4 intersect the first deposited channels components. A second suite of components (e.g. one or more components B of one or more concentrations B1, . . . Bm) is then dispensed into feed holes 2, and deposited along channels that intersect the first set of deposited channels of the first one or more components A at one or more different concentrations, as illustrated in FIG. 11B. In a similar manner, the second set of deposited films may be treated, and the receiving plate 6 may be detached from the flow distribution body 1, now having multiple intersections of components, which may now be scanned for interactions of interest.

In another embodiment, the receiving plate 6 may remain afixed to the flow distributor body 1 after the dispensing of the first suite of fluids, and any subsequent treatment as known in the art. The first suite of fluids may be flushed from the channels 4 of the distributor body 1 by using appropriate fluids, such as a buffer solution as known in the art, which will not remove the previously deposited first components or interact with the first suite of components. The first deposited channels may be allowed to dry, depending upon the application. Then a second suite of components may be dispensed into the channels 4 as before. The second suite of components may be treated, depending on the application as known in the art. The surface of the receiving plate 6 may then be analyzed, such as with a scanner, to evaluate any interactions that may have occurred. Additional sets of components may also be dispensed and analyzed, as desired.

In yet another embodiment, the receiving plate 6 may be provided with another pattern of components deposited by other methods known in the art, such as an array of dots, and then channels of other reagents or components may then be deposited in accordance with the present invention, and analyzed for any interactions of interest.

The use of a test kit 80 having a flow distribution body 1 that includes a capillary flow control mechanism 5 has the benefit that the trailing meniscus 37 will maintain the fluid within the capillary channel 4 without air pockets, and allows additional quantities of the same fluid to be dispensed into the feed hole 2, join the existing fluid at the valve 5 without introducing an air pocket, and allow the fluid to continue to flow within the channel 4, allowing dispensing of multiple units of fluid for certain applications.

The method of this invention is useful in pharmaceutical, health and chemical industries for testing the interactions of multiple chemical or biological agents, such as drug interactions, immunosensing, protein characterization, DNA analysis, capillary electrophoresis and cell patterning. The present invention has the advantage that very small amounts of reagents or components can be provided in a small scan region, which provide savings in the cost of reagents and improved speed of analysis and testing.

It will be appreciated by those skilled in the art that the method and application to various layouts in accordance with the present invention is not limited to the embodiments discussed above. Accordingly, the invention is intended to encompass all such alternatives, modifications and variations which fall within the scope and spirit of the invention and the following claims.

1. An apparatus for testing reagents, the apparatus comprising:
a flow distribution body having a plurality of conduits that are flow-isolated from each other, wherein each flow-isolated conduit comprises:
a feed hole having a first opening at a first surface of said flow distribution body, wherein said feed hole terminates at a flow control means;
a capillary channel having an interior surface bounded by a receiving surface, said capillary channel being flow-connected to said feed hole through said flow control means; and
at least one capillary flow promotion chimney flow-connected to said capillary channel so that fluid flowing along said capillary channel from said feed hole will enter said at least one capillary flow promotion chimney and promote continuous flow along said capillary channel.

2. The apparatus of claim 1 wherein said flow control means comprises a constricted opening so that a trailing meniscus of fluid flowing from said feed hole into said capillary channel stops at said constricted opening.

3. The apparatus of claim 1 wherein said feed hole is tapered from a first opening at said first surface to said flow control means so that fluid introduced into said feed hole from said first opening flows continuously along said feed hole from said first surface to said flow control means.

4. The apparatus of claim 3 wherein said flow control means comprises a constricted opening.

5. The apparatus of claim 1 wherein said feed hole has a volume less than 10 μliter.

6. The apparatus of claim 1 wherein said at least one capillary flow promotion chimney comprises a plurality of capillary flow promotion chimneys having a collective volume equal to or less than the volume of said feed hole.

7. The apparatus of claim 1 wherein said receiving surface comprises a surface of a sealing plate comprising a material having sufficient adhesive properties so that each of said capillary channels are flow-isolated from each other and permit said sealing plate to be released from said flow distribution body.

8. The apparatus of claim 7 wherein said receiving surface of said sealing plate comprises polydimethylsulfoxide or polydimethylsiloxane.

9. The apparatus of claim 1 wherein said flow distribution body is afixed to a sealing plate comprising said receiving surface, said sealing plate afixed to said flow distribution body by means of an adhesive having properties so that each of said capillary channels are flow-isolated from each other and permit said sealing plate to be released from said flow distribution body.

10. The apparatus of claim 1 wherein said capillary channel has a width less than 150 μm.

11. The apparatus of claim 1 wherein said flow distribution body comprises a dense material that is inert to fluids and reagent components therein to be tested.

12. The apparatus of claim 1 wherein said flow distribution body comprises sintered, patterned greensheets.

13. The apparatus of claim 1 wherein said plurality of conduits have a surface roughness sufficient to provide a desired wettability.

14. A method of manufacturing an apparatus comprising a flow distribution body, said method comprising the steps of:
providing a three-dimensional network design of flow channels in said flow distribution body;
decomposing said three-dimensional network design into a plurality of discrete patterned layers;
patterning a plurality of green sheets corresponding to said plurality of discrete patterned layers; and
assembling said plurality of patterned green sheets to form said flow distribution body so that said flow distribution body has no substantial permeability between said flow channels.

15. The method of claim 14 wherein said flow distribution body comprises a plurality of flow-isolated conduits wherein each flow-isolated conduit includes a feed hole, said feed hole terminating at a capillary flow control means, and at least one capillary flow promotion chimney, wherein said flow distribution body is afixed to a receiving plate to form a capillary channel bounded by a receiving surface of said receiving plate, said capillary channel connected to said feed hole through said capillary flow control means, and said at least one capillary flow promotion chimney connected to said capillary channel so that fluid flowing along said capillary channel from said feed hole will enter said at least one flow promotion chimney and promote continuous flow along said capillary channel.

16. The method of claim 14 wherein said step of assembling said plurality of patterned green sheets comprises laminating at a pressure and temperature to avoid deformation of said three-dimensional network of flow channels.

17. The method of claim 14 wherein said step of assembling said plurality of patterned green sheets comprises laminating at a pressure less than about 1000 psi and at a temperature less than about 90° C.

18. The method of claim 14 wherein said step of assembling said plurality of patterned green sheets comprises laminating and sintering said patterned green sheets at a temperature and pressure to avoid deformation of said three-dimensional network of flow channels.

19. The method of claim 14 wherein said step of assembling said plurality of patterned green sheets comprises sintering at a temperature less than 1500° C.

20. The method of claim 14 wherein said patterning comprises overlap punching.

21. The method of claim 14 wherein said patterning comprises overlap punching using a single punch size.

22. The method of claim 15 further comprising forming a patterned adhesive layer on a surface of said flow distribution body having patterned openings corresponding to said capillary flow control means of said feed holes and said at least one capillary flow promotion chimney so that said flow distribution body may be afixed to said receiving plate by means of said adhesive layer to form said capillary channels.

23. The method of claim 22 wherein said forming a patterned adhesive layer further comprises the steps of:
forming a resist layer on said surface of said flow distribution body corresponding to said capillary flow control means;
patterning said resist layer to form caps of resist covering said capillary flow control means and said at least one flow promotion chimney;
forming a layer of polydimethylsulfoxide on said surface between said caps of resist; and
removing said caps of resist.

24. The method of claim 23 further comprising filling said feed hole and said at least one capillary flow promotion chimney with a wax prior to said step of forming a resist layer, and removing said wax after said step of removing said caps of resist.

25. A method of testing multiple reagents comprising the steps of:
providing a test apparatus comprising a plurality of flow-isolated conduits wherein each flow-isolated conduit includes a feed hole formed in a flow distribution body, said feed hole terminating at a capillary flow control means, and at least one capillary flow promotion chimney, wherein said flow distribution body is afixed to a receiving plate to form a capillary channel bounded by a receiving surface of said receiving plate and connected to said feed hole through said capillary flow control means, and said at least one capillary flow promotion chimney connected to said capillary channel so that fluid flowing along said capillary channel from said feed hole will enter said at least one flow promotion chimney and promote continuous flow along said capillary channel;
dispensing a first fluid comprising a first reagent into one of said feed holes, so that a layer of said first reagent is formed on said receiving surface along the corresponding said capillary channel; and
dispensing a second fluid comprising a second reagent into one of said feed holes, so that a layer of said second reagent is formed on said receiving surface along the corresponding said capillary channel so that said layer of said second reagent interacts with at least a portion of said layer of said first reagent.

26. The method of claim 25 wherein a volume of said first fluid and a volume of said second fluid are each less than or equal to the volume of said feed hole, and wherein said at least one capillary flow promotion chimneys comprise a plurality of capillary flow promotion chimneys having a collective volume substantially equal to or less than the volume of said feed hole.

27. The method of claim 25 wherein said capillary channels are configured within an area less than or equal to the area capable of being analyzed by a single scan of a scanner.

28. The method of claim 25 wherein said capillary channel has a volume about one order of magnitude less than the volume of the corresponding feed hole.

29. The method of claim 25 wherein said receiving plate is released from said flow distribution body after said step of dispensing said first fluid and afixing said receiving plate to a second flow distribution body so that said layer of said first reagent on said receiving plate is oriented at a non-zero angle to said capillary channels of said second flow distribution body.

30. The method of claim 25 further comprising dispensing a rinsing fluid after said step of dispensing said first fluid and prior to dispensing said second fluid.

31. A method of testing multiple reagents comprising the steps of:
providing a test apparatus comprising a flow distribution body comprising a plurality of flow-isolated conduits wherein each flow-isolated conduit includes a feed hole terminating at a capillary flow control means, and at least one capillary flow promotion chimney;
providing a receiving plate having a receiving surface having formed thereon at least one layer of a first reagent;
afixing said receiving plate to said flow distribution body to form a capillary channel bounded by said receiving surface of said receiving plate and connected to said feed hole through said capillary flow control means, and said at least one capillary flow promotion chimney connected to said capillary channel so that fluid flowing along said capillary channel from said feed hole will enter said at least one flow promotion chimney and promote continuous flow along said capillary channel; and
dispensing a second fluid comprising a second reagent into one of said feed holes, so that a layer of said second reagent is formed on said receiving surface along the corresponding said capillary channel so that said layer of said second reagent interacts with at least a portion of said layer of said first reagent.

32. The method of claim 31 wherein said afixing said receiving plate is performed by means of a patterned adhesive layer.

33. The method of claim 31 wherein said receiving plate comprises a material having adhesion sufficient to form said capillary channels when afixed to said flow distribution body.
